(19) United States
(12) Patent Application Publication
(10) Pub. No.: US 2014/0024247 A1
(43) Pub. Date: Jan. 23, 2014

(54) WRAPPABLE EXTENSION CORD APPARATUS AND RELATED METHODS

(71) Applicant: Quirky, Inc., New York, NY (US)

(72) Inventors: Jacob Niels RIESGAARD, Bonaire, GA (US); Jessica FUGLER, New York, NY (US); Jordan DIATLO, New York, NY (US); Nicholas OXLEY, New York, NY (US); Faris ELMASU, New York, NY (US)

(21) Appl. No.: 13/943,409

(22) Filed: Jul. 16, 2013

Related U.S. Application Data
(60) Provisional application No. 61/672,859, filed on Jul. 18, 2012.

(51) Int. Cl. H01R 11/01

(52) U.S. Cl. CPC H01R 11/01
USPC 439/502

(57) ABSTRACT

At least one exemplary aspect comprises an apparatus comprising: (a) a plug component at a first end of a cord; (b) an outlet component at a second, opposite end of the cord; and (c) a gooseneck component that encloses at least a portion of the cord.

### CROSS-REFERENCE TO RELATED APPLICATIONS

This application claims priority to U.S. Provisional Patent Application No. 61/672,859, filed Jul. 18, 2012, entitled “Wrappable Extension Cord Apparatus.” The entire contents of the above-referenced application are incorporated herein by reference.

### INTRODUCTION

An exemplary embodiment comprises a wrappable extension cord apparatus that comprises an extension cord component connected to a plug component at one end and connected to an outlet component at an opposite end. A flexible gooseneck component (i.e., a flexible, jointed pipe) lies between the two ends.

Exemplary methods of use comprise: wrapping around a bed post, in order to provide power for a laptop, clock, or other device; wrapping around the leg of a ladder, to provide power to power tools (without the cords hanging loose); and attaching to a leg of a desk, to preclude the need to reach under the desk to plug into an outlet.

At least one exemplary aspect comprises an apparatus comprising: (a) a plug component at a first end of a cord; (b) an outlet component at a second, opposite end of the cord; and (c) a gooseneck component that encloses at least a portion of the cord.

In various exemplary embodiments: (1) the gooseneck component comprises an aluminum armature component; (2) the aluminum armature component is over molded with a flexible plastic sleeve; (3) the gooseneck component comprises a thermoplastic assembly comprising individual units; (4) the thermoplastic assembly is enclosed in a thermoplastic elastomer tube; (5) the thermoplastic is polycarbonate; (6) the gooseneck component is attached to the outlet component; (7) the outlet component comprises a plurality of outlets; (8) the apparatus further comprises one or more USB ports; (9) at least one outlet in the outlet component accepts a non-U.S. plug; (10) at least one plug in the plug component conforms to a non-U.S. outlet; (11) the apparatus further comprises a surge protector; (12) at least one outlet in the outlet component is a grounded outlet; and (13) at least one outlet in the outlet component is an ungrounded outlet; (14) at least one plug in the plug component is a grounded plug; and/or (15) at least one plug in the plug component is an ungrounded plug.

Other aspects and embodiments, including methods of use and manufacture, will be apparent to those skilled in the art after reviewing the description and drawings provided herein.

### BRIEF DESCRIPTION OF THE DRAWINGS

FIG. 1 depicts an exemplary embodiment of a wrappable extension cord apparatus.

FIG. 2 provides an exemplary component/materials description.

FIGS. 3-5 depict perspective views of an exemplary embodiment of extension cord apparatus 100.

FIGS. 6-8 depict perspective views of components forming an exemplary embodiment of apparatus 100.

FIGS. 9-14 depict perspective views of an exemplary embodiment of extension cord apparatus 100.

FIG. 15 provides another exemplary component/materials description.

### DESCRIPTION OF SELECT EXEMPLARY EMBODIMENTS

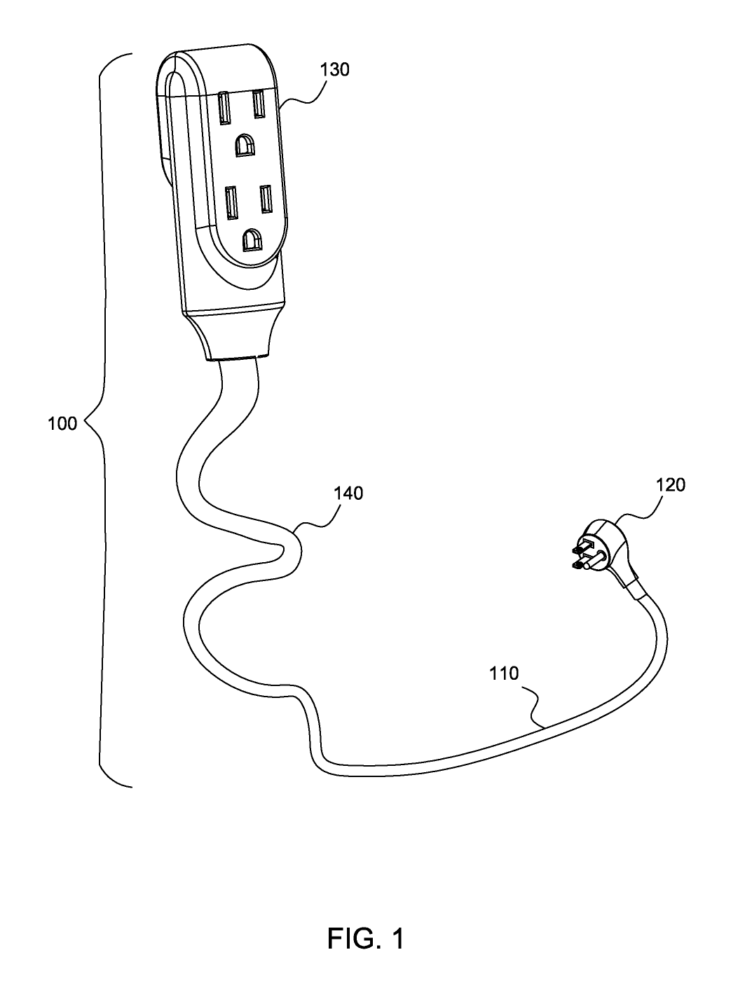

FIG. 1 depicts an exemplary embodiment of a wrappable extension cord apparatus. In this embodiment, the apparatus 100 comprises an extension cord component 110 connected to a plug component 120 at one end and connected to an outlet component 130 at an opposite end. A flexible gooseneck component 140 lies between the two ends.

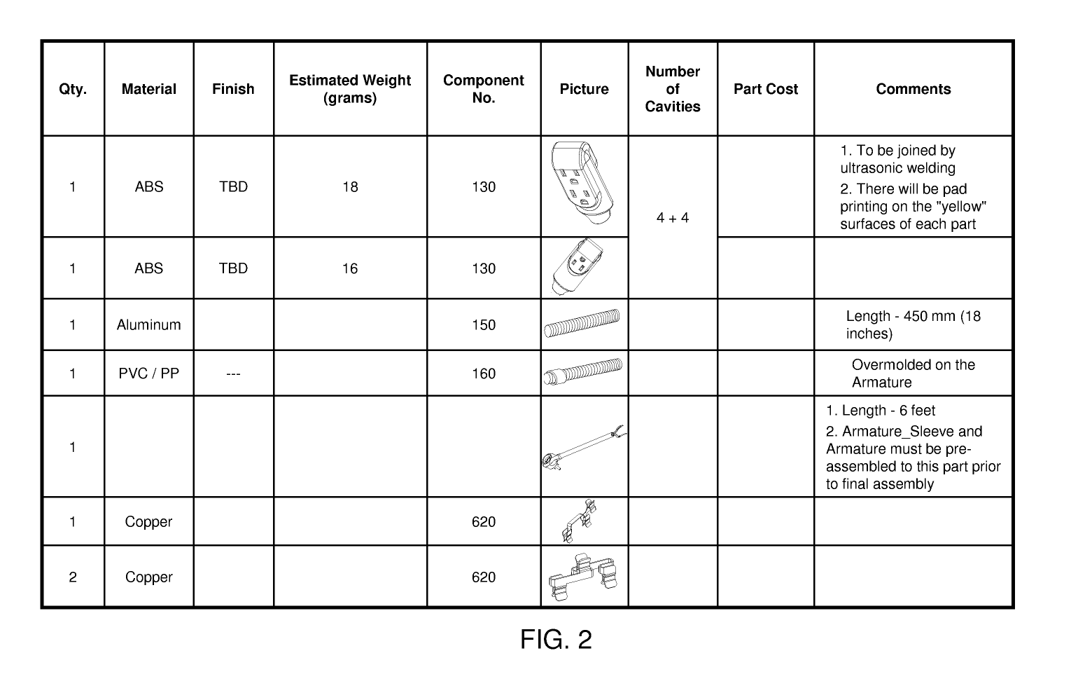

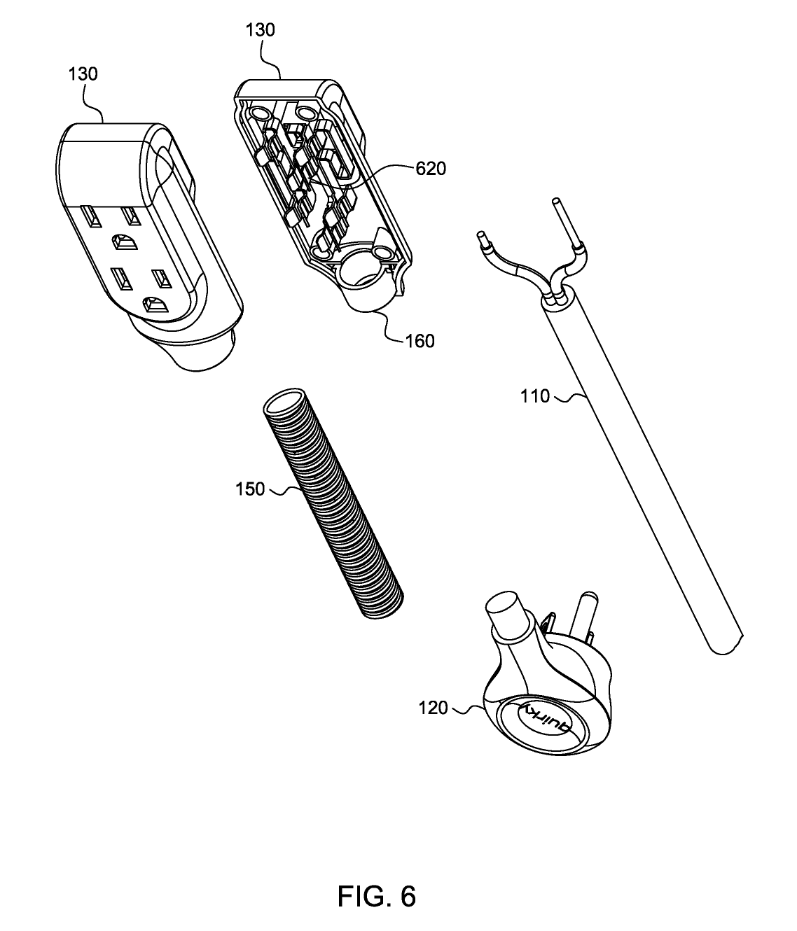

The gooseneck component 140, in an exemplary embodiment, may be, for example, approximately 18 inches long and may comprise an aluminum armature component 150 wrapped around a section of extension cord component 110 and then over molded with a flexible plastic armature sleeve 160. See FIGS. 2 and 6.

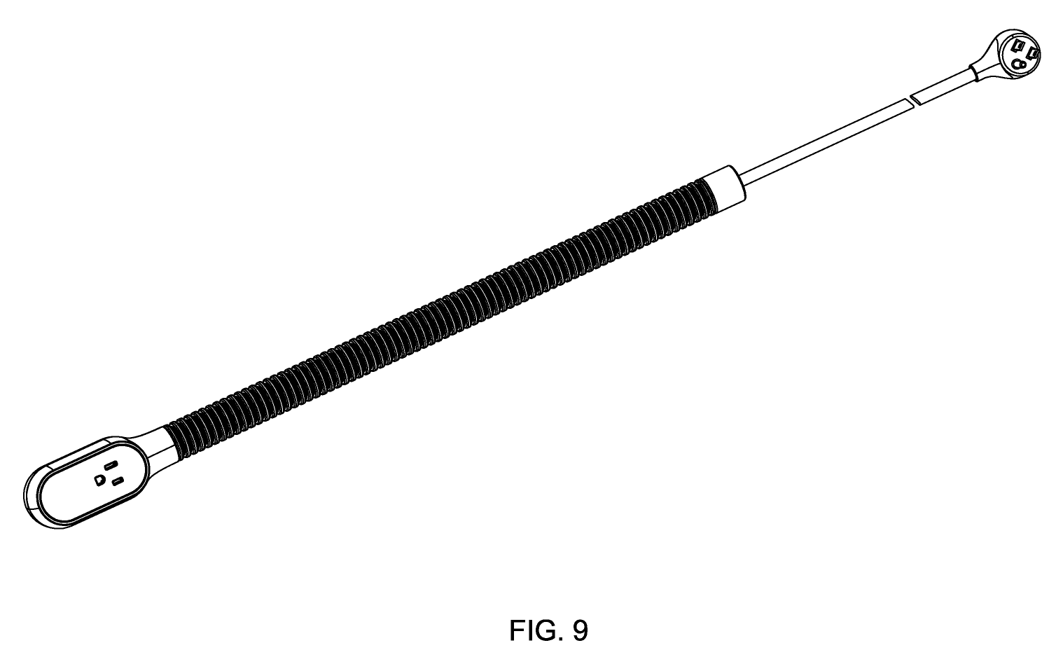

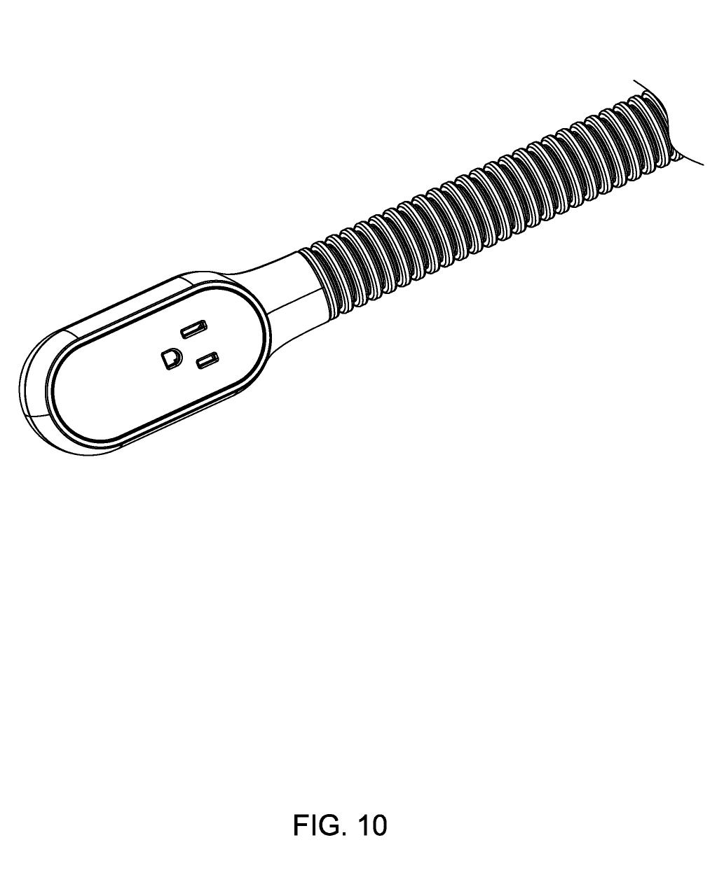

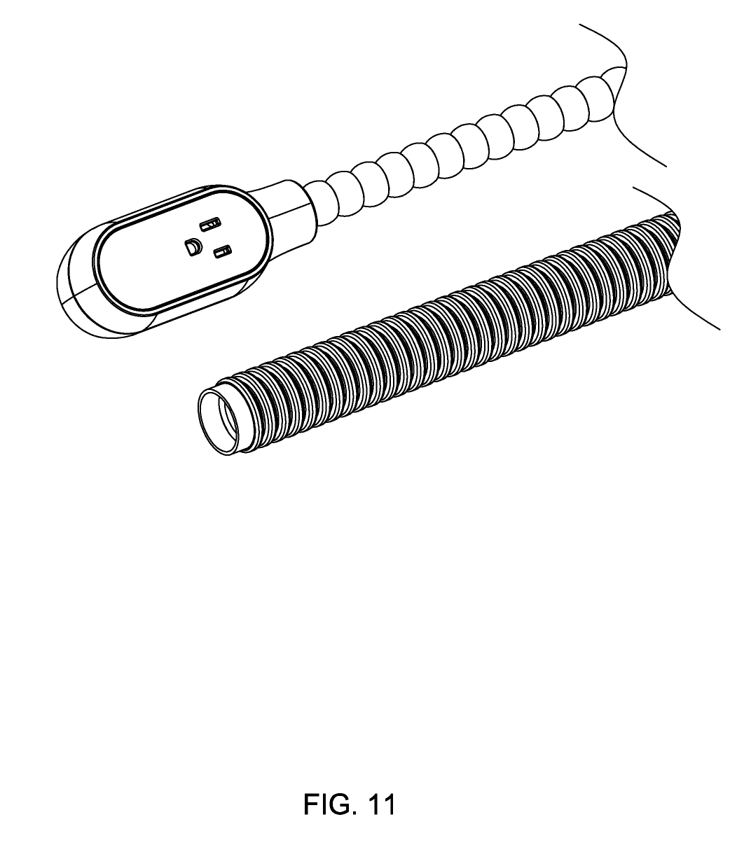

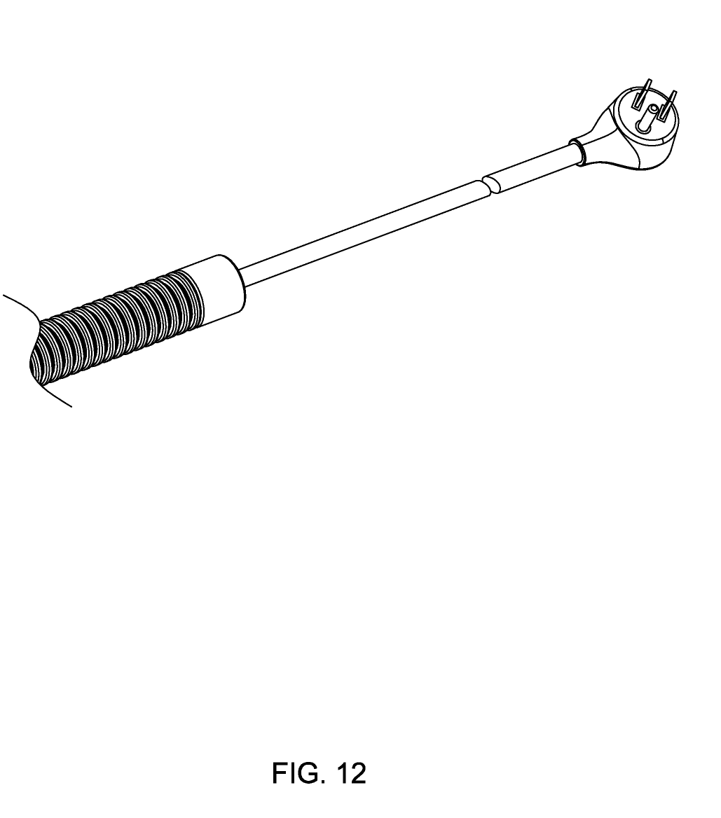

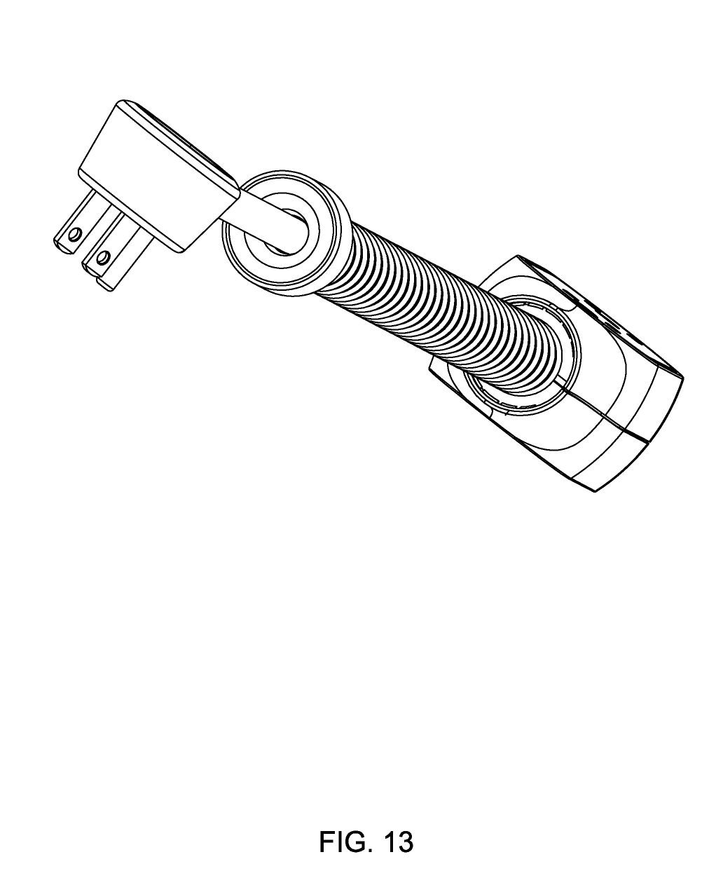

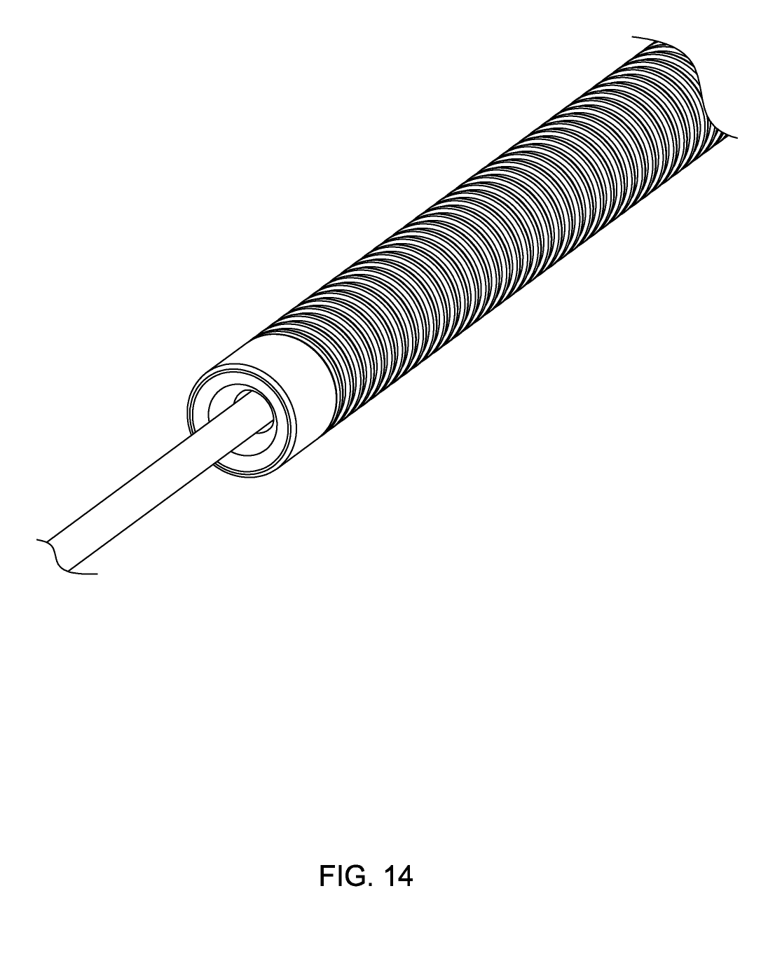

In another exemplary embodiment, component 150 is a thermoplastic (polycarbonate) assembly made up individual units acting like the vertebrae of a spine, and component 160 is not overmolded, but instead comprises a corrugated, flexible tube made of thermoplastic elastomer into which the gooseneck assembly is inserted. See FIGS. 9-15.

The gooseneck component allows for positional flexibility, and may be any suitable length. Extension cord component 110 also may be any suitable length; standard lengths are 6, 9, and 12 feet.

Exemplary methods of use comprise: (a) a user wrapping the gooseneck component around a bedpost (for example, to plug in and charge a cellphone); (b) a user working on a ladder and wrapping the gooseneck component around the leg of the ladder so that power tool cords are not dangling; and (c) a user wrapping the gooseneck component around a work desk component (for example, to plug in a monitor), in order to avoid using a power strip located under the desk.

In an exemplary embodiment, the main body of outlet component 130 is made, for example, of polycarbonate (PC) or ABS plastic, and the internal contact points for electricity are made of copper. See FIGS. 2 and 6. However, those skilled in the art will understand that various materials may be used to manufacture the components of extension cord apparatus 100.

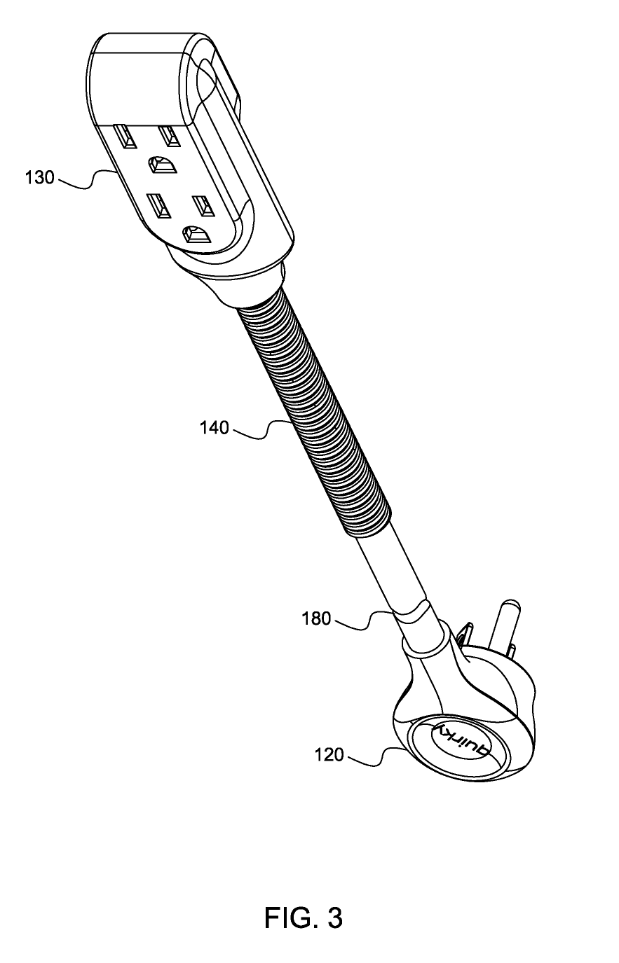

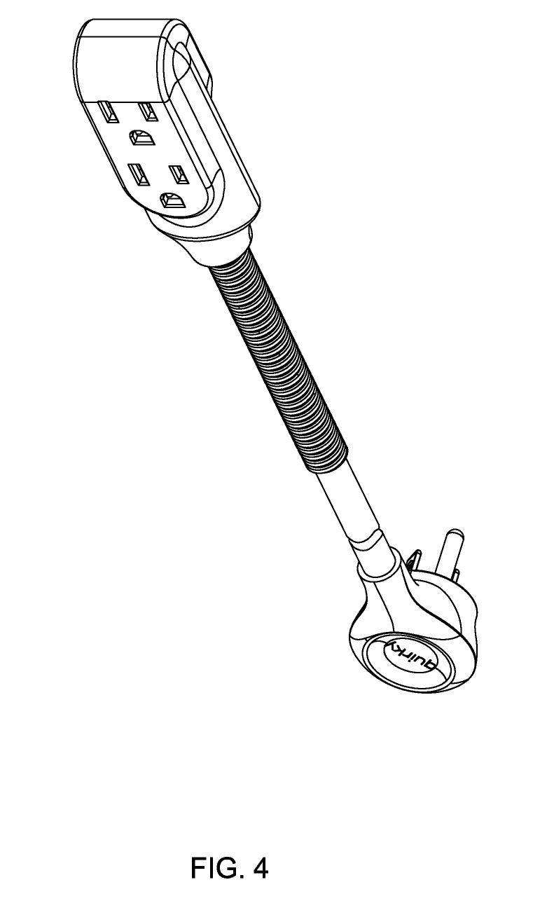

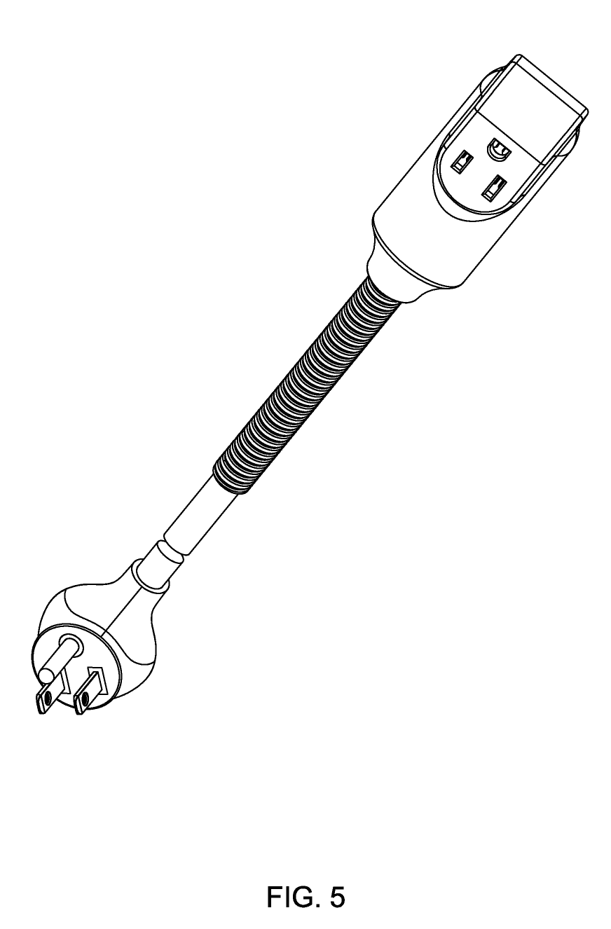

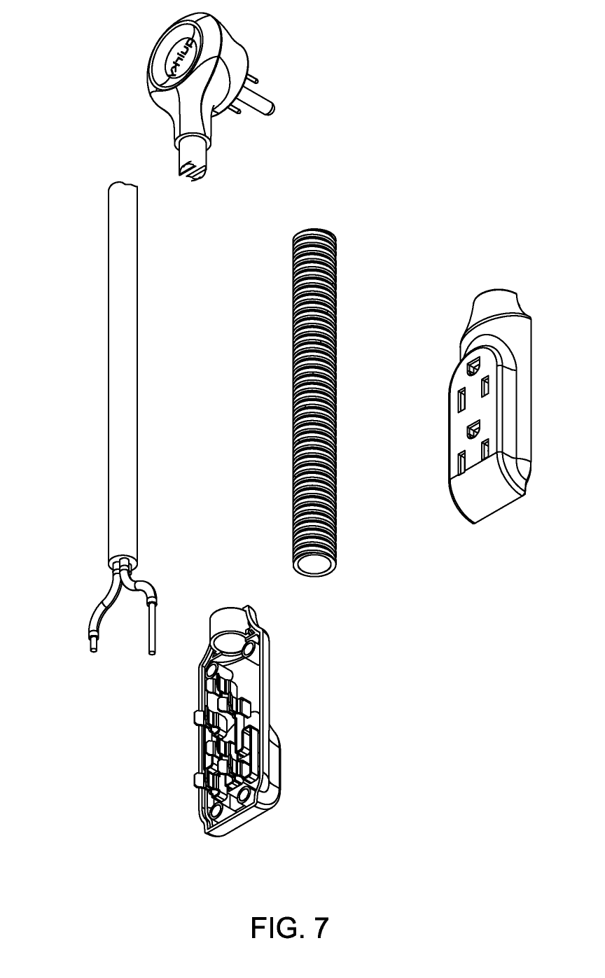

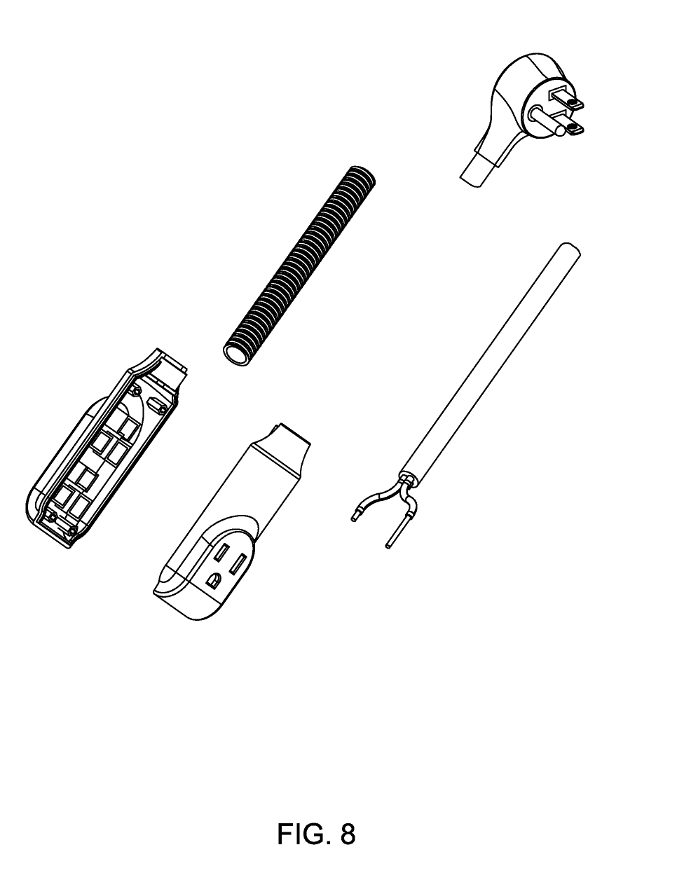

FIGS. 3-5 depict perspective views of extension cord apparatus 100, while FIGS. 6-8 depict perspective views of components forming apparatus 100.

In FIGS. 3-5, extension cord apparatus 100 is shown in an “unwrapped” configuration, wherein gooseneck component 140 is essentially straight. Moreover, much of extension cord component 110 is not shown, and is represented by the gap 180 between plug component 120 and gooseneck component 140.

FIGS. 6-8 depict apparatus 100 in exploded views, showing various components separately. As shown, armature 150 may be attached to outlet component 130 via armature sleeve 160. Outlet component 130 may comprise internal contact points 620, which may be made of copper (see FIG. 2).

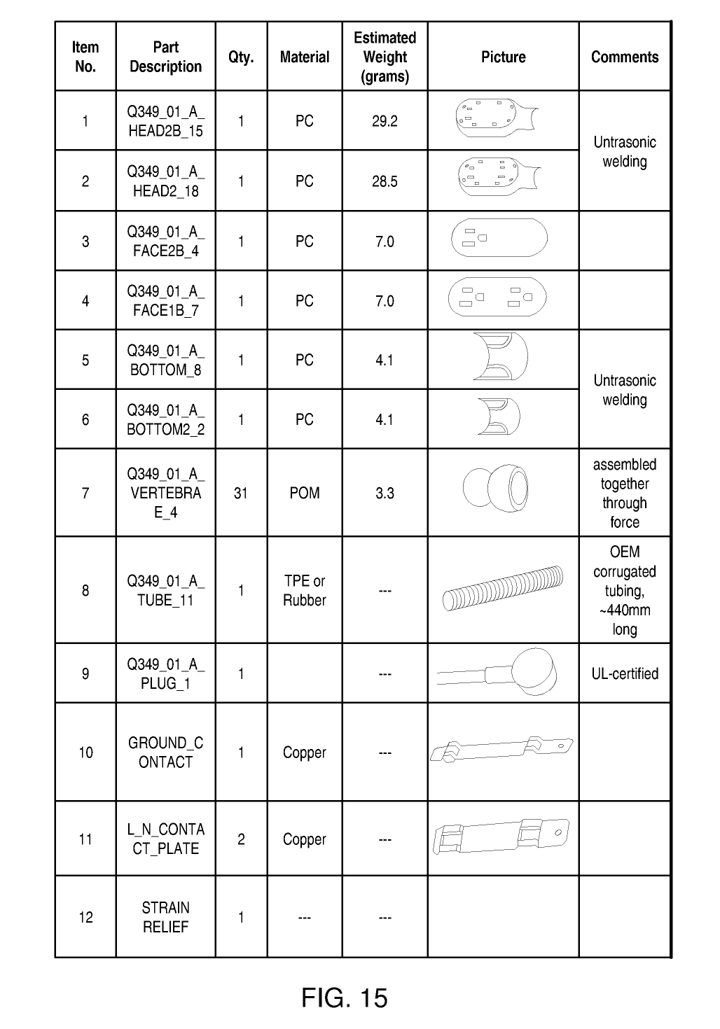

FIGS. 9-14 depict perspective views of an exemplary embodiment of extension cord apparatus 100. FIG. 15 provides an exemplary component/materials description for that embodiment.

While certain exemplary aspects and embodiments have been described herein, many alternatives, modifications, and variations will be apparent to those skilled in the art. For example, in one or more exemplary embodiments: (a) the outlet component may comprise multiple outlets, for example on each side, and may have more than two sides; (b) the apparatus (e.g., the outlet component) may comprise one or more USB ports; (c) the apparatus may comprise one or more surge protectors; and (d) the outlets and plugs may conform to various non-U.S. and international standards (e.g., BS 546, CEE 7, etc.), and be grounded or ungrounded, polarized or not polarized.

Accordingly, exemplary aspects and embodiments set forth herein are intended to be illustrative, not limiting. Various modifications may be made without departing from the spirit and scope of the disclosure.

We claim:

1. An apparatus comprising:
a plug component at a first end of a cord;
an outlet component at a second, opposite end of said cord; and
a gooseneck component that encloses at least a portion of said cord.

2. An apparatus as in claim 1, wherein said gooseneck component comprises an aluminum armature component.

3. An apparatus as in claim 2, wherein said aluminum armature component is over molded with a flexible plastic sleeve.

4. An apparatus as in claim 1, wherein said gooseneck component comprises a thermoplastic assembly comprising individual units.

5. An apparatus as in claim 4, wherein said thermoplastic assembly is enclosed in a thermoplastic elastomer tube.

6. An apparatus as in claim 4, wherein said thermoplastic is polycarbonate.

7. An apparatus as in claim 1, wherein said gooseneck component is attached to said outlet component.

8. An apparatus as in claim 1, wherein said outlet component comprises a plurality of outlets.

9. An apparatus as in claim 1, further comprising one or more USB ports.

10. An apparatus as in claim 1, wherein at least one outlet in said outlet component accepts a non-U.S. plug.

11. An apparatus as in claim 1, wherein at least one plug in said plug component conforms to a non-U.S. outlet.

12. An apparatus as in claim 1, further comprising a surge protector.

13. An apparatus as in claim 1, wherein at least one outlet in said outlet component is a grounded outlet.

14. An apparatus as in claim 1, wherein at least one outlet in said outlet component is an ungrounded outlet.

15. An apparatus as in claim 1, wherein at least one plug in said plug component is a grounded plug.

16. An apparatus as in claim 1, wherein at least one plug in said plug component is an ungrounded plug.
